(19) United States
(12) Patent Application Publication
(10) Pub. No.: US 2010/0077918 A1
(43) Pub. Date: Apr. 1, 2010

(54) CYLINDER FOR HIGH-PRESSURE HYDRAULICS

(75) Inventors: Margit Hölzl, Vorchdorf (AT); Othmar Hölzl, Vorchdorf (AT); Martin Fiedler, Himberg (AT); Rudolf Mark, Windischgarsten (AT)

Correspondence Address: LERNER, DAVID, LITTENBERG,;KRUMHOLZ & MENTLIK, 600 SOUTH AVENUE WEST, WESTFIELD, NJ, 07090, US

(73) Assignee: MARK METALLWARENFABRIK GMBH, SPITAL AM PYHRN (AT)

(21) Appl. No.: 11/720,305

(22) PCT Filed: Nov. 24, 2005
(86) PCT No.: PCT/AT2005/000472

§ 371 Date: Sep. 22, 2009

(30) Foreign Application Priority Data
Nov. 25, 2004 (AT) A 1980/2004

(51) Int. Cl. F15B 15/14

(52) U.S. Cl. 92/169.2

(57) ABSTRACT

A cylinder for high-pressure hydraulics is disclosed, with a cylinder sleeve extending between a cylinder base and a cylinder head composed of an inner tube and an outer sleeve made from fiber-reinforced plastic placed on the inner tube. According to the invention, a weight reduction without loss of rigidity may be achieved, whereby the inner tube of the cylinder sleeve screwed to the cylinder base and joined to the outer sleeve in a thrust-resistant or shear-resistant manner engages with the cylinder head in a tensile-resistant manner.

### CROSS-REFERENCES TO RELATED PRIOR ART

The application is a 371 U.S. national phase application of the international application PCT/AT2005/000472 (WO 2006/055997A1), filed Nov. 24, 2005, which claims benefit of Austrian application A1980/2004 filed Nov. 25, 2004. All references cited in this specification, and their references, are incorporated by reference herein in their entirety where appropriate for teachings of additional or alternative details, features, and/or technical background.

### FIELD OF INVENTION

The invention relates to a cylinder for high-pressure hydraulic systems, with a cylinder sleeve extending between a cylinder base and a cylinder head, using an inner tube and an outer sleeve made from fiber-reinforced plastic placed over the inner tube.

### BACKGROUND

A known way (DE 69 16 307 U) of avoiding the susceptibility of metal pressure cylinders to corrosion and reducing weight is to make the cylinder sleeve between a cylinder base and a cylinder head connected to the cylinder base by tie rods from a glass fiber-reinforced plastic tube. However, these known pressure cylinders are not suitable for high-pressure hydraulic systems operating at hydrostatic pressures in excess of 200 bar, for example. It has therefore been proposed (EP 0 701 065 B1) that the cylinder sleeve be made from a thin-walled, metal inner tube and a fiber-reinforced outer sleeve, which is slightly pre-tensioned by means of tie rods. The radial compression forces are transmitted via the thin-walled inner tube to the fiber-reinforced outer sleeve, which absorbs these compression forces without any fear of impairment to the cylinder's sealing properties, because the outer sleeve of fiber-reinforced plastic remains unaffected by axial tensile stress. The axial forces induced by the high-pressure hydraulic system are absorbed exclusively by the tie rods. The disadvantage of these known cylinders is that the tie rods needed to absorb the axial forces not only make the component more complex and increase the cylinder dimensions, but also result in an increase in weight.

### SUMMARY OF THE INVENTION

Accordingly, the underlying objective of the invention is to propose a cylinder for high-pressure hydraulic systems of the type outlined above, which is based on a simple construction principle but does not require tie rods to absorb the axial forces.

This objective is achieved by the invention due to the fact that the inner tube of the cylinder sleeve screwed to the cylinder base and joined to the outer sleeve in a thrust or shear-resistant manner engages the cylinder head in a tensile-resistant manner.

Due to the fact that the inner tube is screwed to the cylinder base and this inner tube is joined to the cylinder head in a tensile-resistant manner, the axial forces which occur can surprisingly be absorbed by the cylinder sleeve, even in a high-pressure hydraulic system, if a composite body which acts in both the circumferential direction and in the axial direction is produced by joining the outer sleeve of fiber-reinforced plastic to the inner tube in a shear-resistant manner. By providing several layers of differently oriented reinforcing fibers, preferably carbon fibers, the outer sleeve of the cylinder sleeve can be readily adapted to the respective load requirements. Dispensing with tie rods therefore means that particularly lightweight pressure cylinders can be produced, which may be used in high-pressure hydraulic systems in spite of the lightweight construction.

The inner tube may be made from metal in a manner known per se, but may also be made from polyether ketone (PEEK), because in either case, not only can the axial tensile forces be absorbed in conjunction with the outer sleeve of fiber-reinforced plastic, the outer sleeve is also protected from direct exposure to the hydraulic medium, which means that the strength properties of the fiber-reinforced plastic can not be detrimentally affected due to hydraulic medium penetrating the micro-pores.

Particularly effective properties can be obtained for the join between the cylinder sleeve and the cylinder base if the outer sleeve of plastic is joined to the cylinder base in a shear-resistant manner and extends across the cylinder base at the end so that the axial forces transmitted to the outer sleeve are not transmitted exclusively via the thrust forces between the inner tube and the outer sleeve. The outer sleeve of fiber-reinforced plastic can easily be joined to the inner tube or cylinder base in a shear-resistant manner by means of a layer of adhesive.

The cylinder head can be joined to the cylinder sleeve in a tensile-resistant manner in the same way as the cylinder base is joined, although this means that the cylinder head can not be removed from the cylinder sleeve subsequently and hence the piston removed. For this reason, the inner tube of the cylinder sleeve has a terminal annular flange at the cylinder head end, around which a sleeve nut provided on the cylinder head engages so that the requisite tensile-resistant connection between the inner tube of the cylinder sleeve and the cylinder head can be assured by this sleeve nut. This being the case, the outer sleeve of fiber-reinforced plastic extends as far as the annular flange at the cylinder head end.

### BRIEF DESCRIPTION OF THE DRAWINGS

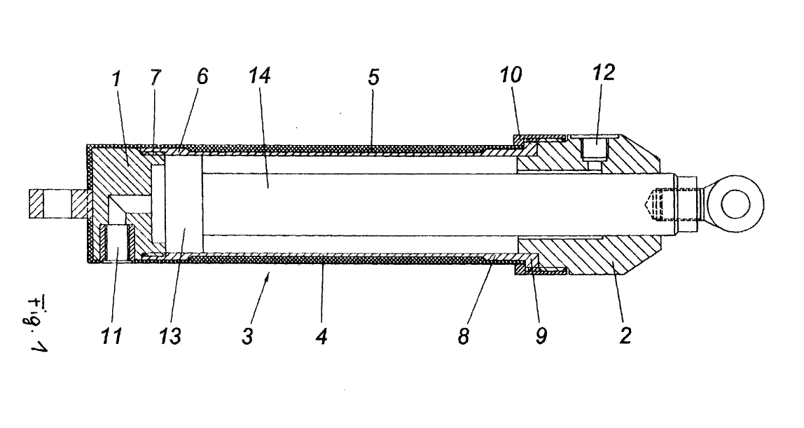

An example of the subject matter proposed by the invention is illustrated in the appended drawing, FIG. 1; and is so in the case of a cylinder proposed by the invention for high-pressure hydraulic systems, viewed in a simplified longitudinal section.

### DETAILED DESCRIPTION OF THE INVENTION

The illustrated cylinder is composed of a cylinder base 1, a cylinder head 2 and a cylinder sleeve 3 extending between the cylinder base 1 and cylinder head 2. The cylinder sleeve 3 is provided in the form of a composite body comprising a thin-walled metal inner tube 4 and an outer sleeve 5 made from fiber-reinforced plastic joined to the inner tube 4 in a shear-resistant manner. Carbon fibers are preferably used for the fiber reinforcement. The choice of plastic will naturally depend on the respective load requirements.

The inner tube 4 has a thicker connecting portion 6 with a thread 7 at the end where the cylinder base 1 is disposed, with the aid of which the inner tube 4 is joined to the cylinder base 1 in a tensile-resistant manner. The inner tube 4 is also provided with a thicker end portion 8 at the cylinder head end, but which forms a terminal annular flange 9. This annular flange 9 has a sleeve nut 10 extending round it, mounted on the cylinder head 2 to enable it to be screwed so that the sleeve nut 10 produces a tensile-resistant connection to the cylinder head 2, which can be removed from the cylinder sleeve 3 once the sleeve nut 10 has been unscrewed.

The outer sleeve 5 of fiber-reinforced plastic extends in the region of the end portion 8 of the inner tube 4 as far as the annular flange 9 and is therefore surrounded by the sleeve nut 10. At the oppositely lying end of the inner tube 4, the outer sleeve 5 extends beyond the thicker end portion 6 and extends across the cylinder base 1 at the end, which advantageously assists the connection of the cylinder sleeve 3 to the cylinder base 1, especially if the outer sleeve 5 is also joined to the cylinder base 1 by a layer of adhesive to impart shearing resistance.

Since the connections 11 and 12 for the hydraulic medium run through the cylinder base 1 and the cylinder head 2, the ability of the cylinder sleeve 3 to withstand load is not impaired by these connections 11 and 12. The radial and axial compression forces are absorbed by the cylinder sleeve 3, and the metal inner tube 4, which is preferably made from a corrosion-resistant steel, protects the outer sleeve 5 made from plastic against direct exposure to the hydraulic medium, so that any micro-porosity of the fiber-reinforced plastic will not lead to a reduction in strength due to a direct contact pressure with the hydraulic medium.

The inner tube 4 may also be made from plastic and in effect from a polyether ketone. This being the case, the inner tube 4 is screwed to the cylinder base in order to obtain a reliable axial connection. The inner tube 4 may additionally be adhered to the cylinder base.

The piston 13 with the piston rod 14 may likewise be made from fiber-reinforced plastic, although not necessarily so. If molding the piston rod 14 from plastic, however, it is recommendable to apply a metal coating in order to improve sealing properties for a high-pressure hydraulic system.

The figures provided herewith depict embodiments that are described as illustrative examples that are not deemed in any way as limiting the present invention.

While the invention has been particularly shown and described with reference to particular embodiments, it will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A cylinder for high-pressure hydraulic systems comprising: a cylinder sleeve extending between a cylinder base and a cylinder head, the sleeve being comprised of an inner tube and an outer tube/sleeve made from fiber-reinforced plastic placed on the inner tube; the inner tube of the cylinder sleeve being screwed to the cylinder base and being joined to the outer sleeve in a thrust-resistant or shear-resistant manner and engaging the cylinder head in a tensile-resistant manner.

2. The cylinder according to claim 1, wherein the inner tube is made from metal in a manner known per se, preferably from steel.

3. The cylinder according to claim 1, wherein the inner tube is made from polyether ketone.

4. The cylinder according to claim 1, wherein the outer sleeve is made from fiber-reinforced plastic which is joined to the cylinder base in a thrust-resistant manner extending across the cylinder base at the end.

5. The cylinder according to claim 1, wherein the outer sleeve made from fiber-reinforced plastic is joined to the inner tube in a shear-resistant manner by means of a layer of adhesive.

6. The cylinder according to claim 1, wherein the outer sleeve comprising fiber-reinforced plastic extends as far as a terminal annular flange of the inner tube at the cylinder head end, and the cylinder head bearing a sleeve nut which extends around the annular flange.
